(19) United States
(12) Patent Application Publication
(10) Pub. No.: US 2018/0130339 A1
(43) Pub. Date: May 10, 2018

(54) SYSTEM & METHODS FOR CRITICAL INFRASTRUCTURE AUTOMATION

(71) Applicant: SENTINELBASE, LLC, ELMHURST, NY (US)

(72) Inventors: MAREK DZIWIREK, MIDDLE VILLAGE, NY (US); DARIUSZ SKARZYNSKI, FRESH MEADOWS, NY (US)

(21) Appl. No.: 15/702,749

(22) Filed: Sep. 12, 2017

Related U.S. Application Data
(60) Provisional application No. 62/393,484, filed on Sep. 12, 2016.

(51) Int. Cl. G08B 29/04; H04L 29/06; H04L 29/08

(52) U.S. Cl. CPC G08B 29/04; G05B 15/02; H04L 67/12; H04L 69/08

(57) ABSTRACT

Aspects of embodiments of the present invention disclose systems, methods and computer programmable product for the monitoring, collection, and processing of facility devices, such as those used in fire alarm systems. Data collected is converted into a different format before being transmitted to one or more servers for further processing. Access to the collected and processed data is made possible using a front-end web interface. Third party, such as local authorities, real-time notification and reporting is also made possible.

Upon receipt of the converted/encoded data from encoder module 504F, server 510 provides access to the data. In an aspect of an embodiment of the present invention, server 510 may conduct additional processing of the data including, without limitation, classification. In another aspect, server 510 may transmit the data as email using email notifications module 512, as text/SMS alerts using text/SMS module 514 and/or event using event module 516 of server 510. In another aspect of an embodiment of the present invention, any one or more of email notifications module 512, text/SMS module 514 and/or event module 516 may be a separate unit, separate from server 510 or belonging (as a part of) to another server.

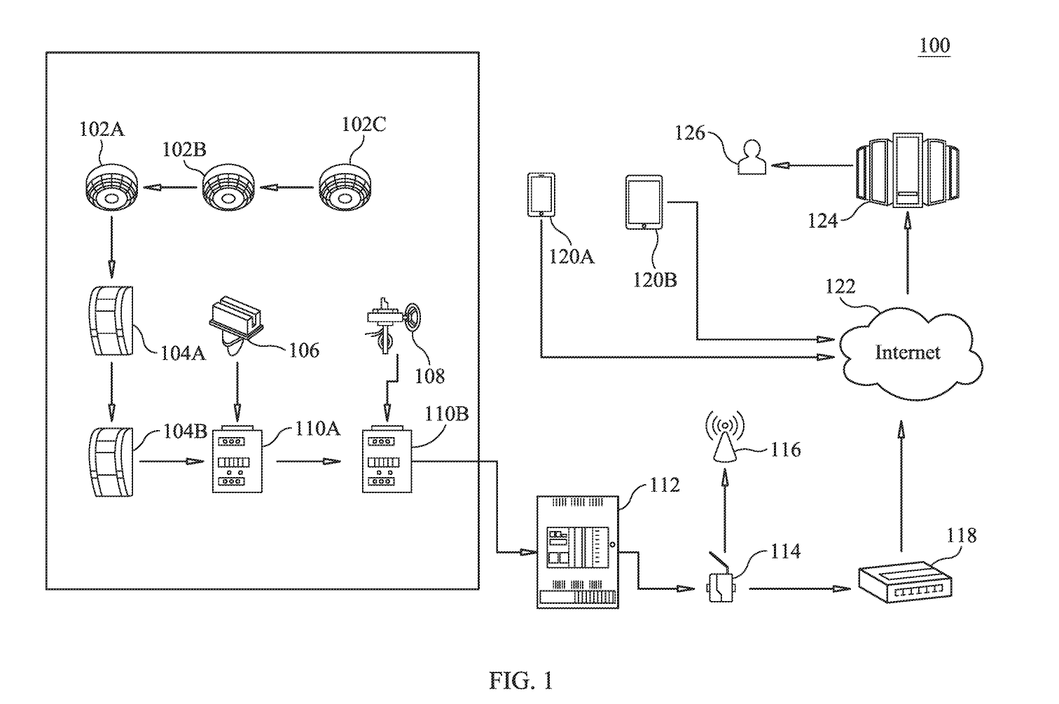

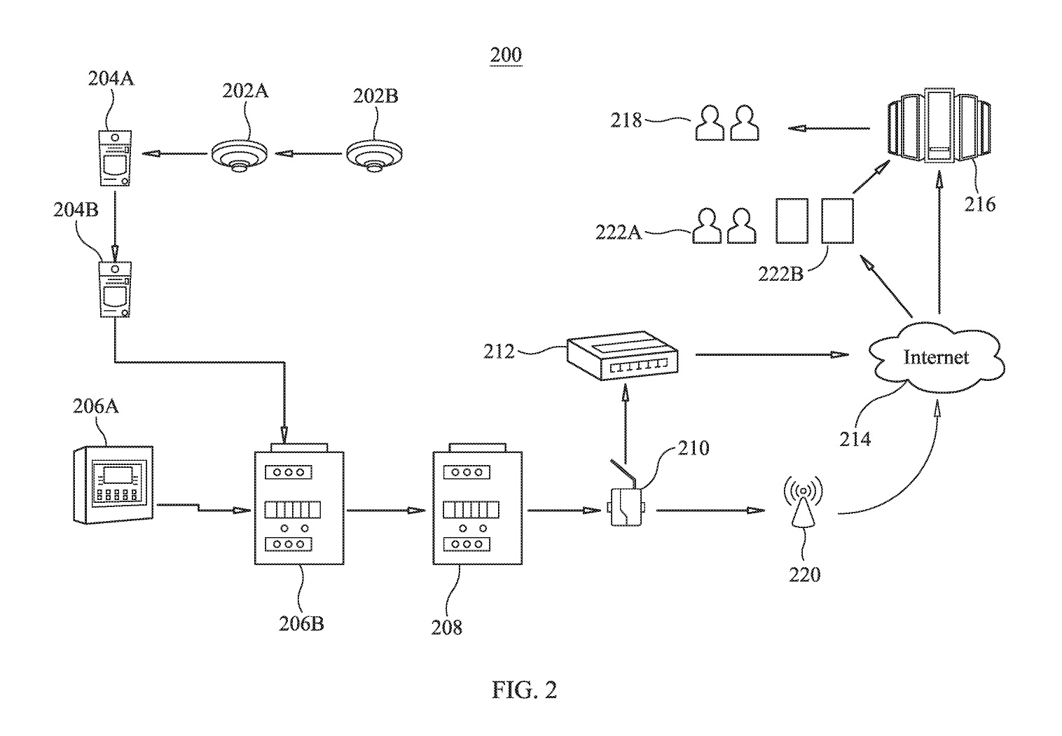

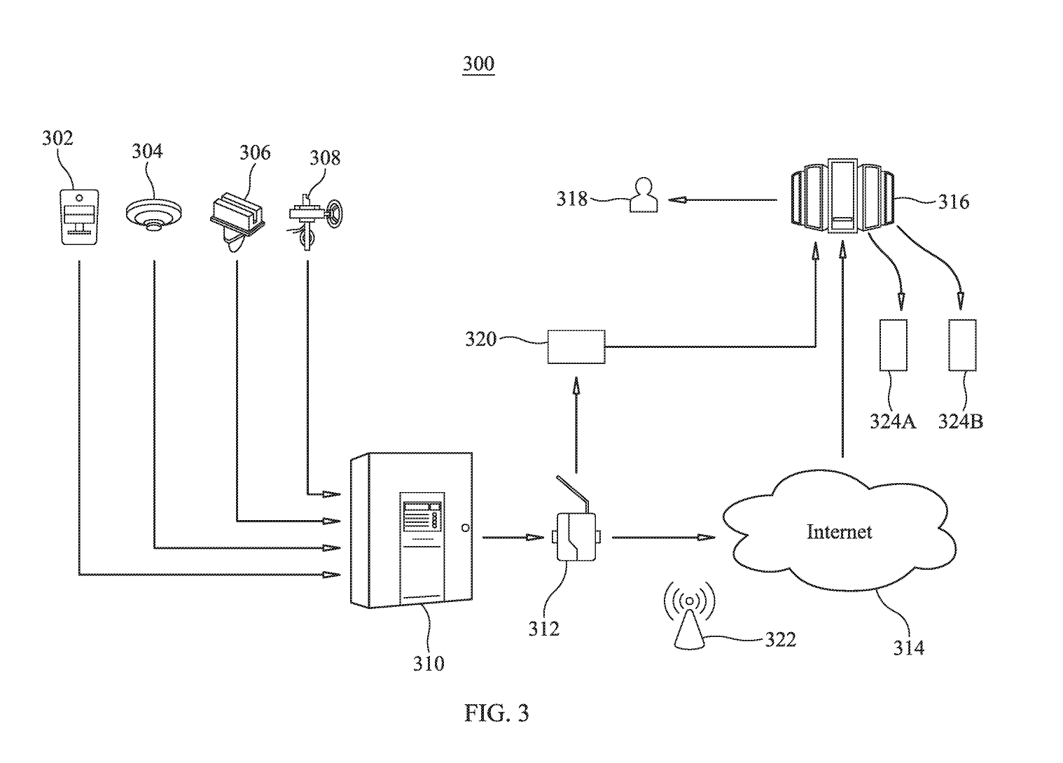

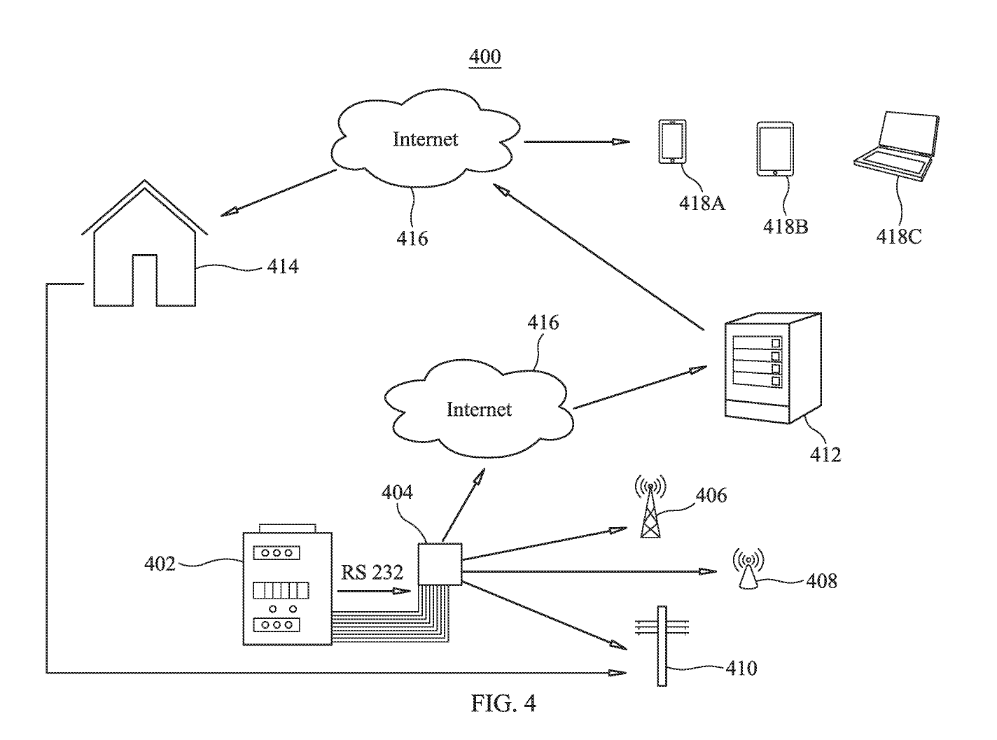

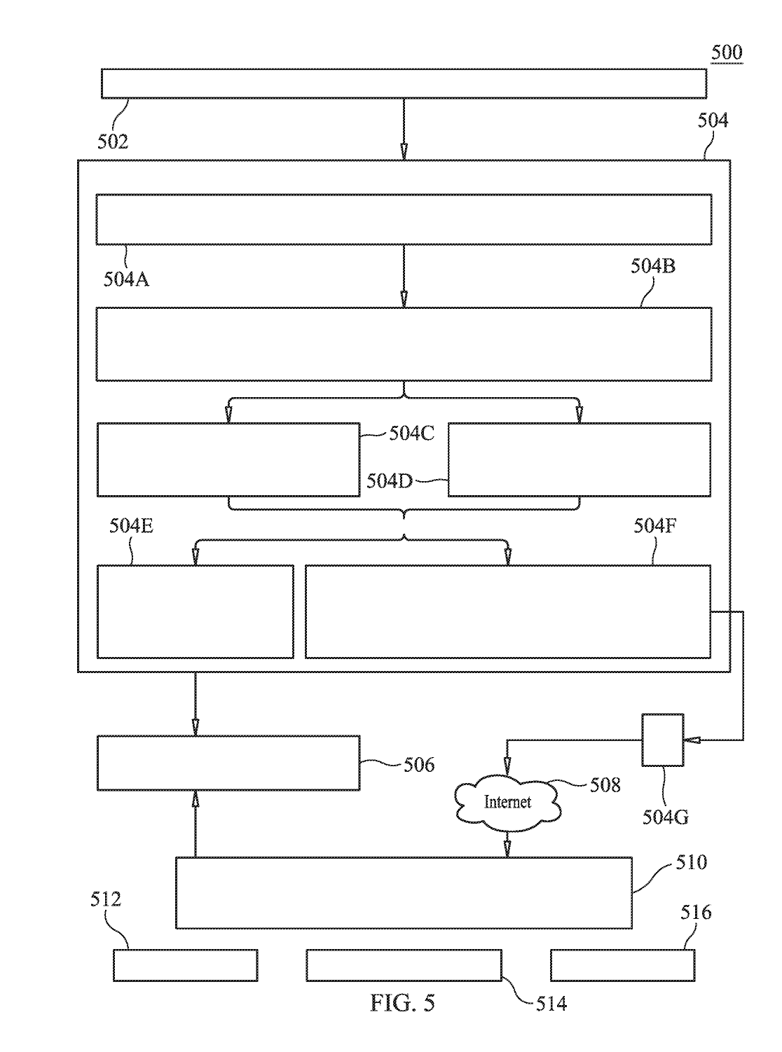

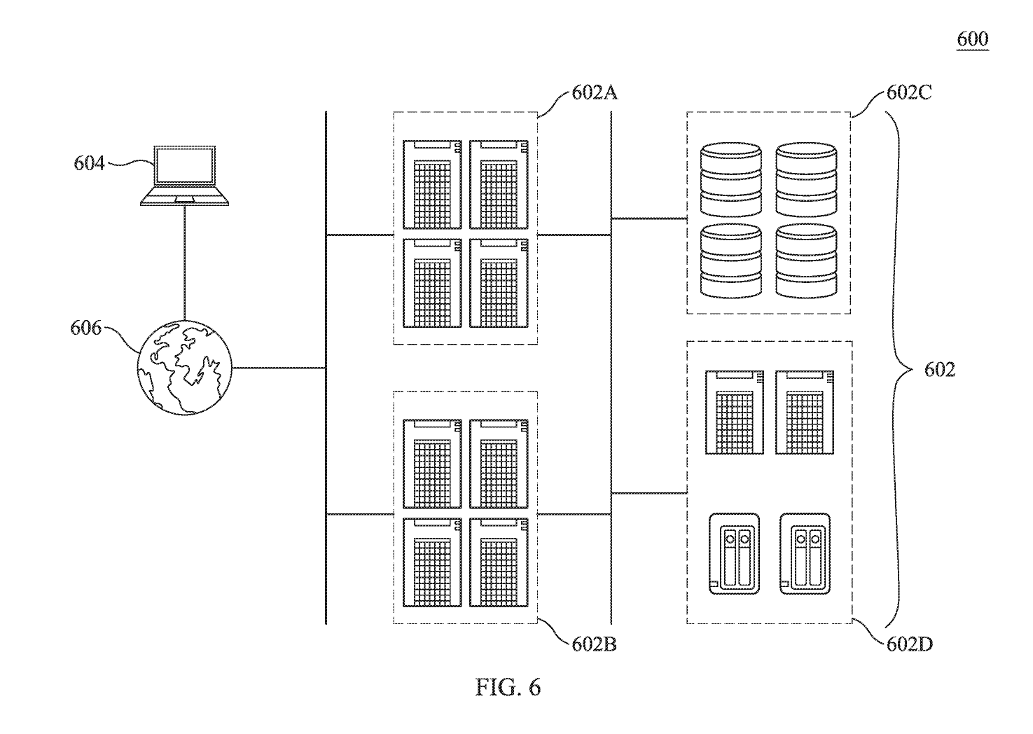

Referring now to FIG. 6 illustrates a system architectural diagram 600 of server 600 and client 602 according to an aspect of an embodiment of the present invention. Server 602 may, in an aspect of an embodiment of the present invention, be any one of servers 124, 216, 316 or 412 as discussed above. Server 602 includes module 602A which handles web traffic coming through internet 60 for system clients and their customers 604. Server 602 may also include module 602B which processes incoming message data including data from protocol conversion device 500. Module 602B may also be a data warehouse for device messages. Server 602 may additionally include module 602C which function to failover backup for data. Finally, server 602 may include module 602D which may be responsible for processing and operations undertaken by modules 512-516.

In an aspect of an embodiment of the present invention server(s) 124, 216, 316 and/or 412 may include code or computer execution instructions that, upon execution by server(s) 124, 216, 316 and/or 412's processors enables user access and ability through the front-end web portal including, without limitation: user access to a real-time log of events, devices, testing information etc., addition or removal of one or more end users, the setting up of one or more logs and access maps, the setting up of report generation system(s) and/or processes for a report, notification of one or more users of an event as received by server(s) 124, 216, 316 and/or 412, and the disabling of one or more accounts.

Execution of the code also enables the following operations of server(s) 124, 216, 316 and/or 412: enabling use of a portal to monitor existing facility equipment systems for alarms, trouble and supervisory condition(s) and sending at least one automatic notification to dedicated personnel, enabling use of a portal to create facility floor plans with indication of every single point being monitored for easy identification and graphical display, portal to assist and to confirm periodic tests of facility devices.

Execution of the code also enables the following operations of server(s) 124, 216, 316 and/or 412: using a server to store test results and making them accessible through a portal, creating automatic test reports and making them accessible through a portal, enabling a portal to connect multiple systems into one unified monitoring platform, enabling use of a portal to receive notifications in form of text messages and emails about the status of monitored equipment, enabling use of a portal to access graphical representation of every device connected to the system and its status, enabling use of a portal to access activity logs for every device that is connected to the system, enabling use of a portal to verify proper testing of the equipment in the protected facility for different claim purposes.

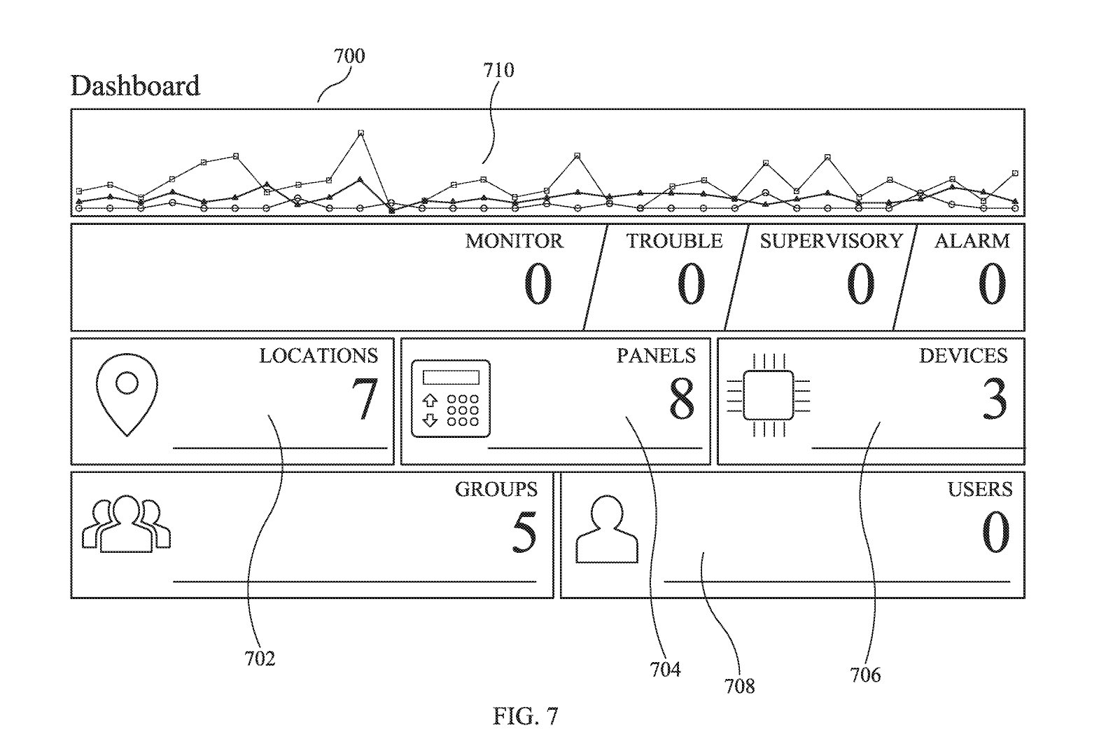

Execution of the code also enables the operation of a front-end web portal which provides access to the system to users, clients, subscribers, vendors, etc. Execution of the code also enables generation of certain aspects of the front-end web portal including exemplary dashboard 700 as illustrated in FIG. 7 showing different aspects of reporting on the system including location 702, panels 704, devices 706, users 708 and a graphical representation/overview of conditions 710. Dashboard 700 maybe accessible by end users using mobile applications or any other access means as previously discussed.

Execution of the code by server(s) 124, 216, 316 and/or 412 enable categorization of messages (Alarm, Supervisory, Trouble, Monitor) sent from to panels from facility devices. An event log, message details (message type, message content, device name, category, sensitivity, node ID, loop ID, address ID, zone ID, panel location, building/facility location, time message was created etc.) may also be generated (by the code's execution by the servers) and printed or saved in the user's desired format.

Operation of server(s) 124, 216, 316 and/or 412 enable, by their processor execution of resident code, enable client features such as notification (e.g. customized messages), reminders (to users with a facility/company), and automatic reminders when services have been requested, a technician has arrived at a site/facility, a technician is on their way, when a proposal has been received, accepted or rejected and when an invoice has been generated and ready. Operation of the server(s) also enable transmission of the reminders via SMS and/or electronic mail.

For new clients, operation of server(s) 124, 216, 316 and/or 412 enable, by their processor execution of resident code, enable new users to shop and purchase system components such as the protocol conversion device, keep a list of orders and inventory. Technicians and vendor maintenance companies may also, by operation of the server(s) schedule technician on file to do jobs, provide details of scheduled jobs and job scheduling.

Operation of server(s) 124, 216, 316 and/or 412 enable, by their processor execution of resident code, system users to manage all existing projects, create new projects, assign projects to individuals, create tasks or service tickets, view scheduled technician arrival, complete tickets, accounting, comments on completed tickets, hours worked, and close of a ticket.

Operation of server(s) 124, 216, 316 and/or 412 enable, by their processor execution of resident code, system administrator tasks, including: management of locations/facilities, compiling a locations list including address building/facility type, time zone, management company, contacts information, central station information such as address, account number, password, primary and secondary phone line. They may also enable the option to add an individual floor plan to each location, drag and drop functionality for doing so, adding a fire panel to a specific building or facility, upload of documents such as closed service reports, proposals, contracts, past test reports etc., ability to enable/disable a central station, data archiving, information input concerning a new test (date, time, test type, test results, download ability of test results, and automated reminders for sensitivity report, and tests result of annual, semi-annual, monthly, quarterly, weekly daily frequency.

Further operation of server(s) 124, 216, 316 and/or 412 enable, by their processor execution of resident code, enable users to manage their employees, create employee files, upload certificates, archive employee files, storage of user account information, storage of company information and GPS tracking of technicians' route.

Aspects of embodiments of the present invention also contemplate computer program product having a computer usable medium with control logic stored on it where the control logic includes computer readable program code for implementing each of the operations of server(s) 124, 216, 316 and/or 412 discussed above.

Further aspects of embodiments of the present invention contemplate the use of non-transitory computer programmable product for the implementation of the different processes or operations outlined above. The same may be found installed on any or all of the components discussed in this application including, without limitation, the devices, panels, protocol conversion devices, servers etc.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as outlined above, in the drawings and the claims presented below.

What is claimed is:

1. A facility system, comprising:
at least one facility device, wherein the at least one facility device monitors a condition within the facility;
at least one facility panel in communication with the at least one facility device, wherein the least one facility panel receives data in ASCII format from the at least one facility device;
at least one protocol conversion device, in communication with the at least one facility panel, wherein the at least one protocol conversion device receives the captured data from the at least one facility panel in ASCII, wherein the at least one protocol conversion device converts the data into JSON format and wherein the converted data is encrypted by the at least one protocol conversion device;
at least one server, wherein the at least one server is in communication with the at least one protocol conversion device, wherein the at least one server receives the converted and encrypted data from the at least one protocol conversion device and wherein the at least one server is configured to execute computer executable instructions to further process the converted data; and
a front-end web interface, in communication with the at least one server, wherein the web interface enables operation and interaction by a user with the system and wherein the front-end web interface enables retrieval and use of the converted data following processing of the converted data by the at least one server.

2. The system of claim 1, wherein the at least one protocol conversion device comprises of a serial port for connection with the facility device.

3. The system of claim 1, wherein the protocol conversion device comprises of a built-in data buffer.

4. The system of claim 1, wherein the facility device includes detectors such as smoke detectors, water flow manual stations, sprinklers, tamper switches.

5. A computer-implemented method for data monitoring, data collection and data conversion, comprising executing on a processor/server, the steps of:
capturing data from at least one facility device, wherein the captured data is in ASCII format;
transmitting the captured data to at least one protocol conversion device;
converting the captured data into JSON, wherein the conversion is done by the at least one protocol conversion device;
encrypting the converted data, wherein the encryption is done by the at least one protocol conversion device;
transmitting the converted and encrypted data to at least one server; and
classification of the transmitted converted and encrypted data.

6. The computer-implemented method of claim 6 further comprising the step of enabling an operator to add additional equipment or sites to the system.

7. The computer-implemented method of claim 6 further comprising the step of enabling an operator to setup any one or more of the following: notifications, blue prints, logs, reports.

8. The computer-implemented method of claim 6 further comprising the step of enabling an operator to receive any one or more of the following: notifications, logs, reports.

9. The computer-implemented method of claim 6 further comprising the step of enabling an operator to check the status of monitored facility device on a facility blue print or floor plan.

10. The computer-implemented method of claim 6 further comprising the step of enabling instant reporting of a condition at a facility device.

11. The computer-implemented method of claim 6 further comprising the step of enabling use of a portal to verify proper testing of the at least one facility device in a protected facility for different claim purposes.

12. A computer program product comprising a computer usable medium having control logic stored therein for causing a computer processor to monitor facility device, said control logic comprising computer readable program code for:
capturing data from at least one facility device, wherein the captured data is in ASCII format;
transmitting the captured data to at least one protocol conversion device;
converting the captured data into JSON, wherein the conversion is done by the at least one protocol conversion device;
encrypting the converted data, wherein the encryption is done by the at least one protocol conversion device;
transmitting the converted and encrypted data to at least one server; and
classification of the transmitted converted and encrypted data.

13. The computer program product of claim 12, further comprising computer readable code for enabling an operator to add additional devices or sites to the system.

14. The computer program product of claim 12, further comprising computer readable code for enabling an operator to setup any one or more of the following: notifications, blue prints, logs, reports.

15. The computer program product of claim 12, further comprising computer readable code for enabling an operator to receive any one or more of the following: notifications, logs, reports.

16. The computer program product of claim 12, further comprising computer readable code for enabling an operator to check the status of monitored facility device on a facility blue print or floor plan.

17. The computer program product of claim 12, further comprising computer readable code for enabling instant reporting of a condition at a facility device.

18. The computer program product of claim 12, further comprising computer readable code for of using a portal to verify proper testing of the equipment in a protected facility for different claim purposes.
